(19) United States
(12) Patent Application Publication
(10) Pub. No.: US 2006/0173785 A1
(43) Pub. Date: Aug. 3, 2006

(54) Interactive agenda for personal and groups activities and projects management

(76) Inventor: Hassan Behbehani, Kuwait (KW)

Correspondence Address: Hassan Behbehani, 13013 Safat, P.O. Box 1262 Safat, Kuwait, KW

(21) Appl. No.: 11/030,103

(22) Filed: Jan. 7, 2005

(51) Int. Cl. G06Q 99/00; H04L 9/00; H04K 1/00

(52) U.S. Cl. 705/54

(57) ABSTRACT

A system and method of planning and managing tasks to be worked out by many entities. The each task has task details relevant thereto including entities to whom task will be assigned and auto identification of task controller (The entity assigning these tasks). The auto identification of task assignee can be altered by system administrator or any other user which has been allowed to do so. The task assignee can also set certain criteria to help and judge weather the task has been completed successfully. These criteria may include pre conditions, before conditions, alternative tasks, next tasks and steps that need to be taken after task execution and also the conditions which should be automatically completed after the task has been executed. The system also facilitate the entities to communicate with other peers through instant communication tools such as Instant Messenger and other tools such as Email. The presented system also help the entities to transfer tasks to the peers through different devices such as screens, message boards, mobile devices, pagers and other devices that can be useful for this purpose. The said system also facilitate for planning and help the users in brainstorming and provides users online help in order to plan effectively. The whole system is based on different sort of hierarchies such as users, groups and projects in order to organize system entities.

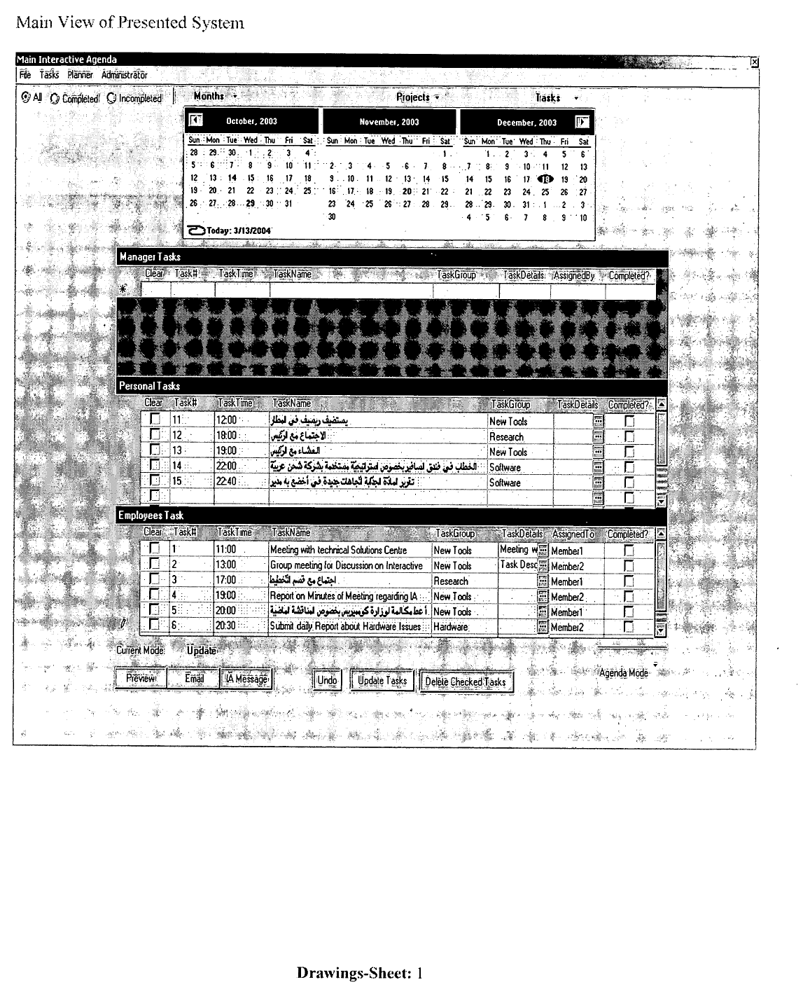

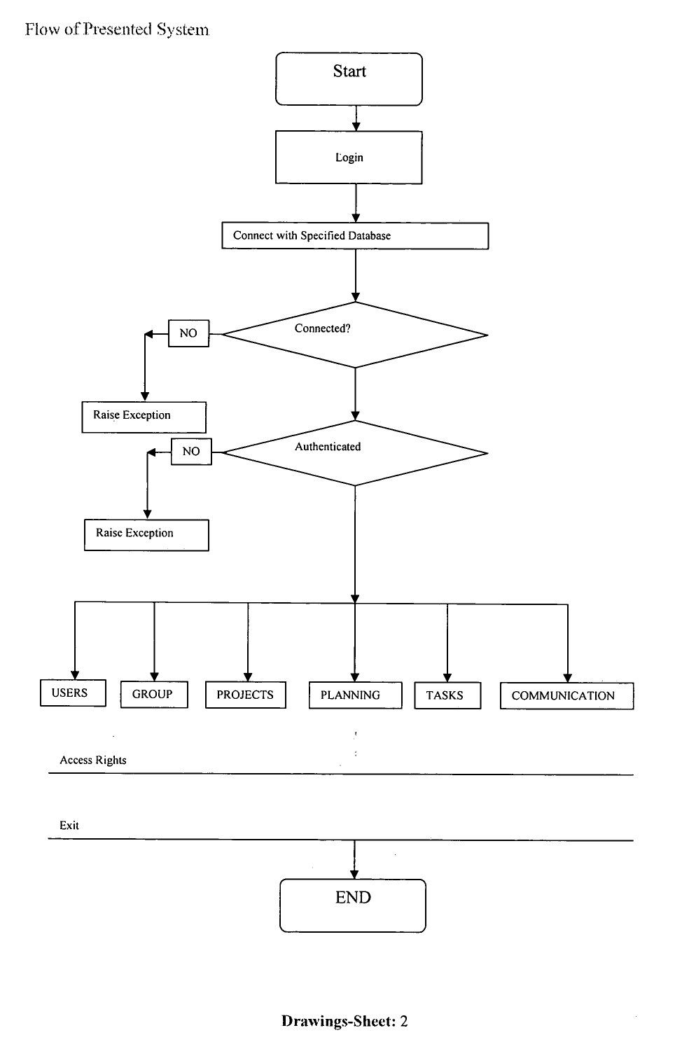

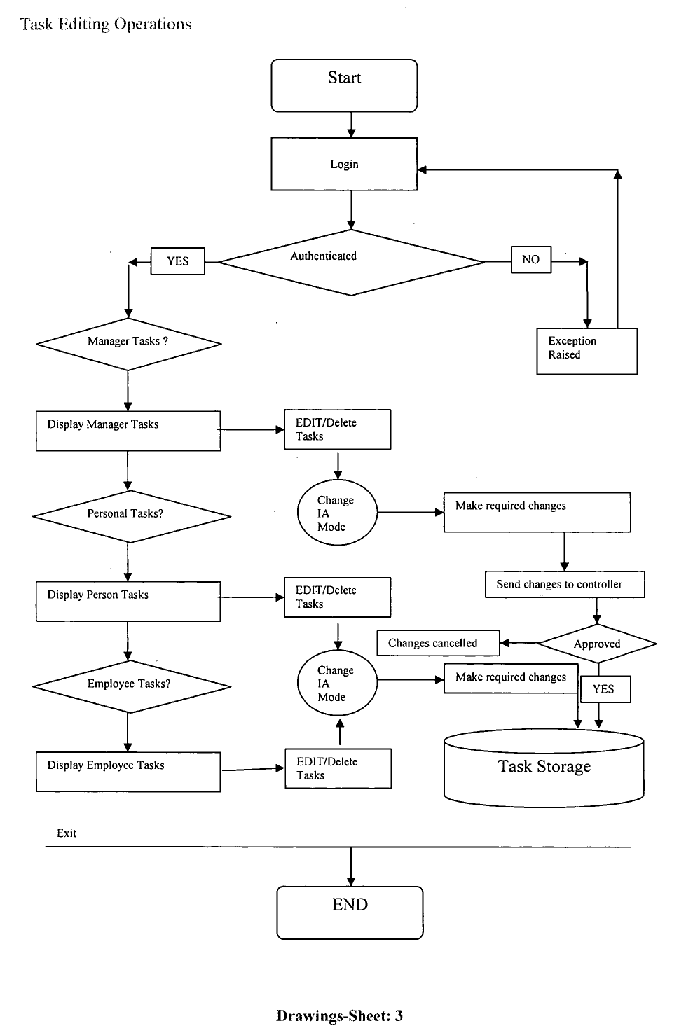

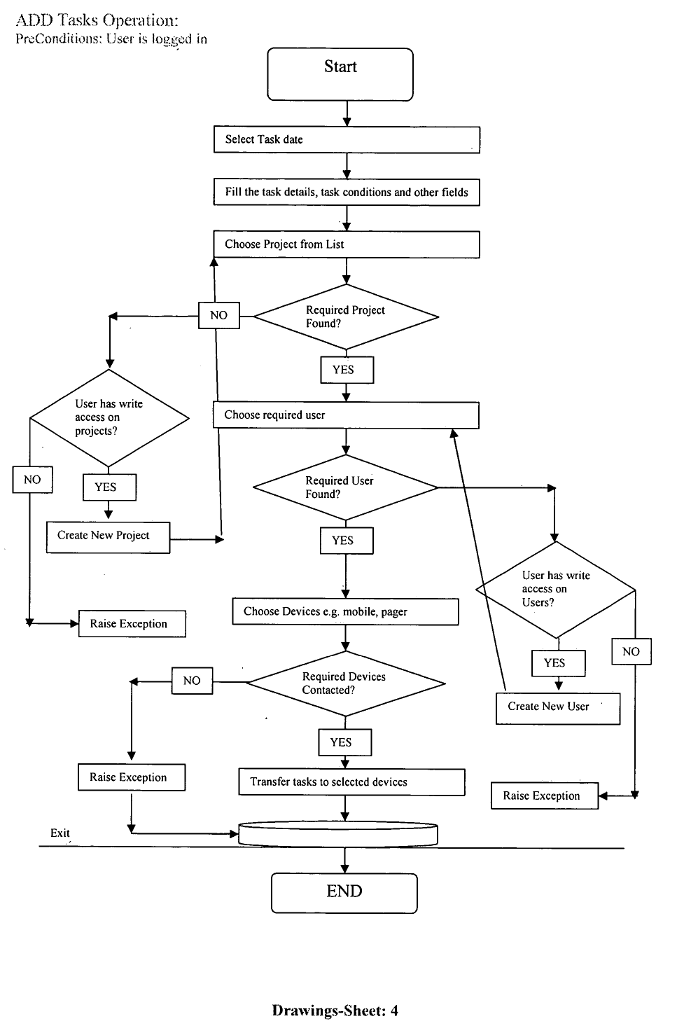

### BACKGROUND OF THE INVENTION

This invention relates to a task planning and management system and to a method of task planning and management.

The invention has particular but not exclusive application to a method of managing a plurality of tasks to be carried out by a plurality of personnel wherein each of the tasks has task details and task completion criteria relevant thereto.

In most of the business environments, organizations have to daily create, gather, analyze and present huge amount of data relating an organization's resources and activities. This data could relate to the daily management activities to the administrative and clerical staff such as planning and managing projects and distribution of these resources to the most appropriate and suitable resources or the distribution and sale of products. In more specific terms the daily process begins with creating the data such as daily task sheets or worksheets and monitoring these daily activities.

In a general project management system, projects and tasks associated with each project must be created and stored in the enterprise or primary database before the project management system to begin collecting data relating to the performance of each project or task. In an enterprise or distributed environment, the project managers and resources they manage (typically people) may be distributed geographically and their connection to the enterprise network and the enterprise database may be periodic or mobile, such as a salesperson traveling or a consultant at a client site. Typically, these remote users enter information offline and later connect to the network via a wide area network (WAN) connection (such as a dialup connection or over the Internet) to upload or download information.

The existing system is also based on the basic logic of existing management systems but have some crucial areas where these system were lacking. The system is not enhanced version of any system rather is new concept through integration of different concepts.

In one prior art system, the project managers create projects and assign tasks offline using a local database resident on their workstation. This local database replicates resource and project information needed by the project manager to manage his or her resources. This information can be updated whenever a connection is established to the enterprise network and the enterprise database. In a similar manner, the manager's resources log hours and costs associated with projects and tasks, also offline, using a local database that replicates the project and task information from the enterprise database.

In one prior art system, the users create tasks and assign these tasks to other users along with task details and other information. Like the traditional systems, tasks are stored and displayed to relevant personnel. Later on the tasks can be modified by the related personnel or according to some modifications protocol operable under the system. Again this system presents good picture how the tasks can be handled effectively but is silent about some areas such as can a personnel can modify or delete the tasks without the permission of the task controller? What is the scope of said task? What to do if the task specified can not be completed due to some reasons, is there any alternative available? How the personnel who is working on task may know task has been completed successfully? Is there anyway to resolve conflicts? and so on . . . .

However the problem with existing systems is that they capture lot of information but mostly ineffective and insufficient to address the various issues. These systems cover users, projects and tasks details. All this information is much conventional in many systems. The systems rottenly do not assist the users who are working on the tasks which should be the core purpose of a project management system. As a result of this, most organizations end with the proud having merged IT into business without taking true benefits of computing. The presented system assist the users in many areas for example, completion criteria as discussed in detailed description of the system helps the users clearly to understand the scope and nature of the tasks. In existing systems a task can be briefed and can be assigned to specific personnel but there is no guidance provided to the personnel responsible for task execution. Moreover these systems do not provide enough information for the users and mangers about the success indicators. Users work on the tasks and complete them but there is mostly they provide no way to judge how effectively a user has achieved certain task and what will be afterwards effects of execution of certain tasks. The presented system has aim to improve these areas.

For example;

Consider the task A assigned to personnel A.

In existing systems, task A is added and assigned to personnel A along with other task details.

In presented system, task A is added, assigned to personnel A with task details as well as other information is provided such as task preconditions (the conditions or tasks which should be automatically completed in order to start the specific task), completion reaction (the tasks or conditions which should be automatically fulfilled after completion of the said task). This simple example clearly indicates how big difference is there between two approaches.

The presented system assist the users in many areas for example, completion criteria as discussed in detailed description of the system helps the users clearly to understand the scope and nature of the task. Moreover these systems do not provide enough information for the users and mangers about the success indicators. Users work on the tasks and complete them but there is mostly they provide no way to judge how effectively a user has achieved certain task and what will be afterwards effects of execution of certain tasks. The presented system has aim to improve these areas.

Moreover existing systems are not efficient enough to enhance the coordination among the users. The presented system also addresses this issue and provides variety of ways to enhance the coordination between the users.

These systems mostly difficult to use and require professional training and skills to use them. These systems use professional terms which are also sometimes problems for the users. Also these systems provide tightly bound environments within the system which results not enough means of tasks delivery to users. The system presented here simple and easy to use and does not require professional users to use them. Any normal PC literate user is able to use the presented system.

The presented system also provides number of ways to deliver the tasks at appropriate destinations. For example, the tasks can be delivered to users through different devices such as mobile, screens and pagers . . . etc. The presented system also provides flexible system administration providing multiple options of the hierarchy such as users and projects. The existing system available on one set of hierarchy such as projects only or users only which is deficiency to manage complex tasks and integrity of complex business logic into the system.

Moreover the said system provides additional facilities such as planning separately without interrupting the main application flow. The system also provides high level interactivity in order to analyze crucial data from multiple users to multiple projects up to small task level which help the managers to made critical decisions such as choose appropriate resources within available resources according to the nature of the project and other relevant factors thereto.

The presented system is not only for commercial use i.e. the system can also be used in other areas than business. For example, the system can also be used for academic purposes. For example, Head of faculty as supervisor of teachers in faculty, teachers in faculty as supervisor of class, class leader as supervisor of students and group leader as supervisor of different groups in a class and so on. The teacher can be project manager and students may be considered as team members. By adopting this approach, students can be monitored on many areas such as subject by subject. The system may also be used to measure performances of students according to various parameters and teacher can assign different students different work according to their performance in many subjects. Similarly presented system obviously can be used to determine he deficiencies of students, teachers can work on skills where some of the students are behind from their peers. The presented system can also be sued to manage research work in academic studies or research organization. The research lead can assign various assignments to his/her fellows and can monitor and control the progress.

The presented system is also helpful for film industry and for actors. For example, the director can be supervisor of different people in team such as cameramen, sound engineers and actors etc and can assign various tasks to team members.

The said system is also useful for professional development. As tasks are assigned to various people, the personnel whom tasks are assigned, work on these tasks. As there are certain conditions are attached with each task, so weaknesses of different personnel can be known and organization can work on these weaknesses to remove them. As tasks have some attached completion criteria, it will also allow supervisors to clearly detect the areas where some personnel are lacking behind. As system is used to detect weaknesses of personnel, it also helps to detect positive things and strong areas of personnel, which helps the supervisors to assign high priority and important tasks to suitable appropriate personnel.

The system has great use when people are working together and there is need for appropriate monitoring and coordination facilities and tools. The said system can also be used for personal use in effective manner in studying or working purpose. The system helps the individuals to streamline their schedules, analyze their weaknesses and effectively plan their projects to enhance their performance at their work but in their personal life as well.

### BRIEF SUMMARY OF THE INVENTION

This invention generally relates to project planning and management and, more particularly, assigning and monitoring of daily and routine activities taking place across an organization.

The presented system is divided into many portions such as users, groups, projects, planning and instant communication. This system is easy and simple to use. The system is governed by administration module which allows managing users, groups, projects and other read and writes access rights into different portions of the system. In the system users can assign plurality of tasks to plurality of users. Tasks are categorized into three major categories such as Manager(s) Tasks, Personal Tasks and Employee(s) Tasks. When user is logged in, he is presented with these types of tasks. Manager Tasks are the tasks which are assigned to logged in user and user is required to work on them and execute them. The personal tasks are the tasks which are assigned by the logged in user to him/her whereas Assigned tasks are the tasks which were assigned by the logged in user to different users. The tasks and other information can be edited by the task controller, administrator or any other user which has the rights to do so. The tasks can also be transferred to different devices but not limited to mobile, screens and pagers . . . etc. The tasks may also used to invoke certain actions remotely or locally but not limited to such as switching off a machine at the specified time. The presented system also provides different facilities such as instant communication to enhance coordination among different users and brain storming tools to in order to effectively plan different projects.

The presented system also facilitates the users/managers to set completion criteria and success condition for different tasks. Managers can make important decisions and can analyze data and change strategy according to captured information. The presented system is also multilingual.

### BRIEF DESCRIPTION OF THE DRAWINGS

Sheet 1:

The drwaing is first main view of presented system. When user is successfully logged in, this page is displayed.

The Calendar shows the date for three successive months. User is able to navigate between them and these underlying panes (grids) are update when user changes the date.

Manager tasks, Personal Tasks and Employee Tasks are the task panes as discussed in detailed description section. The panes are customizable and may vary and have different fields with different headers.

The menu is used to access different portions of the system.

Sheet 2, 3 and 4 are explanation as shown in drawings headings.

### DETAILED DESCRIPTION OF THE INVENTION

Throughout the description and drawings various terms and expressions are used with meanings as per the following definitions.

USERS: The part of the system that allows managing the users.

GROUPS: The portion of the system that allows logical grouping of entities working in the organization where the system is being used. Groups may be such as Management, Finance, HR, Accounts, IT . . . etc

PROJECTS: The part of the system in which all the running projects are managed. A project is a logical collection of tasks that must be completed to achieve the project aim.

PLANNING: The represent the module that controls the planning part.

The words having all letters capital represent a virtual module or part of the system. The parts integrated together form the system.

The presented invention is virtually divided into many sections named USERS, GROUPS, PROJECTS, PLANNING, and INSTANT COMMUNICATION. USERS, GROUPS and PROJECTS are aimed to establish project's team and supervision hierarchy to be used during project execution. USERS basically allow the administrator to make an organization in which users are working. The USERS are the users which can assign plurality of tasks to different users and to whom plurality of tasks can be assigned. The users can be setup/edited by the administrator or any other users that have the authority to manage the users. During users setup process information is captured about the user including personal details of the user and other important information that is used to form the logic for retrieving relevant information with the projects and other routine tasks. This information may be but not limited to user immediate supervisors, the projects on which user is working on and user contacts to which users can contact with the specified user.

A project is a logical collection of tasks that must be completed to achieve the project aim. The leader of the project, who is usually called the project manager, uses both project management and general management methods to complete the project on time and to the desired performance standards. To keep the system specific many users can execute the project and may play the role of project manager simultaneously. The system allows the flexibility to become any user the manager and subordinate. Authenticated users are able to create new projects, edit projects and delete projects.

The groups are logical grouping of different users. To keep the system flexible and easy to use a set of users who belong to specific department are going to be work on specific tasks can make a group. A group is actually classification of users on the basis of their nature of work on some other factor relevant thereto. All the authenticated users who have rights to write groups can create groups, edit groups and delete groups. In order to keep system's integrity, deleting groups may have no effect on other information such as Users in specific group are previous tasks under this group. Similarly deleting projects may have the same effects depending on the action settings of deleting projects.

The tasks when created have some default information attached with the task. This information may be but not limited to initial responsibility of tasks (The creator of a task has initial responsibility by default), task date (The date at which task is assigned), task number. The creator or administrator or any other user having right to change the tasks can change this responsibility if someone else becomes responsible for the task. The person responsible can create sub-tasks and make other people responsible for the sub-tasks.

After creation of tasks more information about the task is captured from the task controller. This information is crucial to understand the full nature and scope of the task. This customizable information may be but not limited task time, task completion date, task project, task details, task completion criteria, task scope, alternative tasks and task begin criteria.

The field named task time represent the time by which task should be completed. Task project is optional field and captures the project under which the task lies. In task details field user may fill variety of information such as full description and steps to execute the specified task. This field also has preconditions (The conditions which should be fulfilled automatically before executing the task), brief description of task comprising the steps need to be taken to complete the task and task reaction (the conditions which should be fulfilled automatically after execution of the task). The brief description of task is highly effective if produced in form of sequential steps but it is not compulsory.

The task completion criteria comprise the conditions and or tasks that should be automatically fulfilled. This may be considered as the completion reaction i.e. occurrence of certain events indicating that task has been completed with success. Task scope helps to understand the person who is going to execute the task to understand the full scope of the tasks and completion criteria of the task. Similarly task begin criteria are the preconditions which should be fulfilled automatically in order to begin the task execution. Alternative Tasks field used to enlists the tasks which can be executed if the task specified can not be completed due to certain reasons. For example, consider a simple task of Delivering a packet through courier company ABC. If due to certain reason this task can not be completed then personnel responsible for the task can deliver through some other company with some changes in the correspondence letter to the company. The task begin criteria helps to impose some conditions or tasks that should be automatically accomplished before the task execution. Virtually this concept is to make parent and child tasks. Next steps are the steps that need to be taken out after completion of the task and alternative tasks are the tasks that need to be carried out if assigned task can not be completed due to some reasons. Task information including or excluding task time, task completion date, task project, task details, task completion criteria, task scope, alternative tasks and task begin criteria can only be modified by the person responsible for the task, administrator or any other users according to access rights policy. In order to keep the system integrity and consistency full task history is available at any time. Once the creator has finished, these tasks are saved into database and are available for action to the assigned users.

The presented system has also different resources of task delivery to appropriate users. The tasks are delivered through tradition manner such as through presented system interface, different devices such as mobile, screens, company notice boards, Email and paging system . . . etc. In order to facilitate the users, instant communication between users is also provided such as messengers having text chat, audio/video chat and conferencing. Like the most instant messaging systems it has all the facilities as well as integration with the presented system such that auto indication for the user when some task is arrived.

The presented system works in simple fashion. Once the tasks and their relevant information have been saved, these are available for action through different means as described in the above paragraph. The users when login into system, the tasks are divided into mainly three categories Manager Tasks, Personal Tasks and Assigned Tasks.

Managers Tasks are the tasks which have been assigned to the logged in user and logged in user have to work on these tasks. Sometimes assigned tasks can not be carried out by the users then users can work on alternative tasks. Also sometimes it is desirable to change the task information including or excluding task time, task completion date, task project, task details, task completion criteria, task scope, alternative tasks and task begin criteria, user may change these details. Users can change these tasks and these changes are delivered to the task controller or manger of these tasks. The modifications made by any user to Manager Tasks have no effect until task controller approve these changes. After approval has been made changes are reflected into these tasks.

If the user has completed specific tasks, user can mark those tasks which have been completed. The manager can view these tasks and can know these tasks have been completed and so next tasks can be assigned to the user.

The personal tasks are the tasks which are assigned by the user to him/her. However personal tasks have different meaning here and may not be totally personal. For example, sometimes managers communicate verbally to users to carry out certain tasks. In this case user can assign task to him/her but these details will be available to managers of the project under which this task has been assigned. However if task is not carried out under any project, these details will be only visible to task creator. Similarly like Manager Tasks completed tasks can be marked so that managers can know that tasks have been completed.

Assigned Tasks or Employees tasks are the tasks which are assigned by the logged in user to various users. These tasks were assigned by the logged in user to different users as manager. The logged in user can now view the tasks progress and can know the tasks which have been completed. From this information, the logged in user can take important decisions and able to change the strategy accordingly as manger of these tasks. The logged in user can assign new tasks, edit previous tasks and can delete the tasks. The administrator can also take the same action. The logged user can also approve/reject any changed to tasks requested by the users to whom tasks were assigned.

Once the tasks have been submitted and transferred, task controller may set to notify the task controller about the receipt of tasks by the various personnel involved in carrying out each task. If this option is set, the tasks when transferred and viewed by the personnel, system sends a receipt to the task controller confirming personnel involved has viewed the tasks.

After tasks have been submitted to the system and are available for execution, task reminders can be sent to the relevant users. However these reminders are not available always and can only sent by the administrator, task controller or the user who is authenticated to do so. Anyway Reminders can be send on different devices such as mobile, pagers . . . etc or through email.

The presented system also provides project planning in order to facilitate planning. In the planning, users initially set their goal. Now to achieve the goal, different steps are taken. A goal is divided into well defined atomic tasks. In order to do effective planning, user enters steps how to achieve a specific task like task details field of the tasks. For tasks, different questions are raised by the system to the user in order to provide inspiration for example, such easy, such difficult; need some help or skipping the task. User provides steps which may again become tasks in order to complete a specific task. This process is continued and plan is said to be ready until all the tasks have been completed thus achieving the desired goal by the user. During the planning process, user is urged on brain storming in order to complete tasks and hence to achieve the goal. During planning process, user is also provided support through different means. For example, system may pop out the internal messenger or Email if user needs some help immediately. The actions associated with questions are customizable and have different sort of actions depending on the nature of plan.

Once the planning is finished, next step is to manage and coordination of the users in order to execute plan. The planning part allows the users to assign resources to different tasks. After assigning resources, this plan is submitted into main flow of the system with one click. Once this plan is available to the system, it is treated similarly like a project and is executed in similar fashion as a project is executed.

What I claim as my invention is:

1. A system of planning and managing multiple projects to be carried out by a plurality of personnel (project manager), each of the projects having plurality of tasks, said including:
identifying plurality of personnel who will be directly involved in carrying out each project and who will supervise plurality of personnel involved in carrying out each project;
identifying plurality of access rights to plurality of personnel involved in carrying out each project and each task;
A method of planning and managing a plurality of tasks to be carried out by a plurality of personnel, each of the tasks having identified task details, identified task completion criteria, identified task scope, identified alternative tasks and identified task begin criteria relevant thereto;
A method of logical grouping of plurality of tasks into categories as the plurality of tasks assigned to a personnel, the plurality of tasks assigned by the personnel to plurality of personnel and plurality of tasks assigned by and assigned to personnel;
Delivering task information including or excluding task details, task completion criteria, task scope, alternative tasks and task begin criteria to task personnel on mobiles, company information screens, company notice boards, pagers or other devices able to display output from the said system;
Exchange of task information including or excluding task details, task completion criteria, task scope, alternative tasks and task begin criteria between task personnel and task controllers such that task information relevant to a task are provided to and accessible by the task controller and the task personnel for said task and or specified group of personnel and/or personnel according to access rights policy.
said system utilizing a data processing assembly operable under the control of program means embodied on a machine-readable storage medium that provides the said system;
access rights policy means for establishing access rights of a personnel to have read or write access to the tasks assigned by specific person (task controller) and or the tasks assigned to a specific person or group (task personnel)

2. A system as recited in claim 1, wherein said system including:
A method of planning and managing a plurality of tasks to be carried out by a plurality of personnel, each of the tasks having task information including or excluding identified task date, identified task time, identified task completion date, identified task project, identified task details, identified task completion criteria, identified task scope, identified alternative tasks, identified task begin criteria relevant thereto;
task information means the information about a specific task comprising task date, task time, task completion date, task project; task details, task completion criteria, task scope, alternative tasks and task begin criteria

3. A method as claimed in claim 2, wherein said method including
auto assigning of task date that is modifiable to new tasks;
identifying project to which a task belongs;
identifying task personnel who will be executing the task;
identifying task group responsible for task completion;
Auto allocation of task controller;

4. A method as claimed in claim 3, wherein said task information including or excluding task details, task completion criteria, task scope, alternative tasks and task begin criteria when transferred are displayed to said task controller and said task personnel or to the personnel having access rights to access tasks of task controller and task personnel.

5. A method as claimed in claim 3, wherein said task information including or excluding task details, task completion criteria, task scope, alternative tasks and task begin criteria when transferred are displayed in messenger if task personnel is online.

6. A method as claimed in claim 3, wherein said task information including or excluding task details, task completion criteria, task scope, alternative tasks and task begin criteria when transferred are delivered to the task personnel through different devices such as mobile, pager, screen or any other sort of device able to display the said information.

7. A method as claimed in claim 3, wherein personnel involved can communicate with other personnel through instant messenger operable under the said system.

8. A method of planning and managing a plurality of tasks to be carried out by a plurality of personnel, each of the tasks having task information including or excluding identified task date, identified task time, identified task completion date, identified task project, identified task details, identified task completion criteria, identified task scope, identified alternative tasks, identified task begin criteria relevant thereto, said method including:
identifying task personnel or group responsible for execution of tasks;
auto allocating task controller who assigns task, and
transferring task information to and/or between task personnel and controllers such that task information relevant to a specific task are provided to and accessible by the personnel assign the task and the task personnel or group responsible for the said task or the personnel according to access rights policy.
wherein task information means the information about a specific task comprising task date, task time, task completion date, task project; task details, task completion criteria, task scope, alternative tasks and task begin criteria
wherein a task information for a task are modified by any one or more of the following operations:
moving a single task;
moving multiple tasks;
copy a single task;
copy multiple tasks;
deleting a task;
deleting multiple tasks;
marking a task for completion;
marking multiple tasks as completed;
copying and pasting a task, and
copy and pasting multiple tasks;
access rights policy means for establishing access rights of a personnel to have read or write access to the tasks assigned by specific person (task controller) and or the tasks assigned to a specific person or group (task personnel)

9. A planning and management system for coordinating a plurality of tasks to be carried out by a plurality of personnel, each of the tasks having task information including or excluding identified task date, identified task time, identified task completion date, identified task project, identified task details, identified task completion criteria, identified task scope, identified alternative tasks, identified task begin criteria relevant thereto, said method including:
transferring task information to and/or between task personnel and controllers such that task information relevant to a specific task are provided to and accessible by the personnel assign the task and the task personnel or group responsible for the said task or the personnel according to access rights policy.
wherein task information means the information about a specific task comprising task date, task time, task completion date, task project; task details, task completion criteria, task scope, alternative tasks and task begin criteria
access rights policy means for establishing access rights of a personnel to have read or write access to the tasks assigned by specific person (task controller) and or the tasks assigned to a specific person or group (task personnel)

10. A planning and management system as claimed in claim 8, wherein each of the task personnel, each task controller and the administrator is provided with a computer and wherein said transfer means comprises a plurality of transient communication linkages between data storage means storing data relating to the task details and the computers of the task controller and the task personnel.

11. A planning and management system as claimed in claim 8, wherein said transient communication linkages are established and removed under the control of a computer program.

12. A management system as claimed in claim 9, wherein said methods are established under the control of said computer program which constitutes said protocol means.

13. A computer program embodied on a machine-readable storage medium that provides a planning and management system for coordinating a plurality of tasks to be carried out by a plurality of personnel or group and governed by access rights policy, each of the tasks having task information including or excluding identified task date, identified task time, identified task completion date, identified task project, identified task details, identified task completion criteria, identified task scope, identified alternative tasks, identified task begin criteria relevant, said system including:
transferring task information to and/or between task personnel and controllers such that task information relevant to a specific task are provided to and accessible by the personnel assign the task and the task personnel or group responsible for the said task or the personnel according to access rights policy.
wherein task information means the information about a specific task comprising task date, task time, task completion date, task project; task details, task completion criteria, task scope, alternative tasks and task begin criteria
access rights policy means for establishing access rights of a personnel to have read or write access to the tasks assigned by specific person (task controller) and or the tasks assigned to a specific person or group (task personnel)

14. A method of a planning and managing plurality of tasks to be carried out by a plurality of personnel or group and governed by access rights policy, each of the tasks having task information including or excluding identified task date, identified task time, identified task completion date, identified task project, identified task details, identified task completion criteria, identified task scope, identified alternative tasks, identified task begin criteria relevant, said system including:
identifying task personnel or group responsible for execution of tasks;
auto allocating task controller who assigns task, and
transferring task information to and/or between task personnel and controllers such that task information relevant to a specific task are provided to and accessible by the personnel assign the task and the task personnel or group responsible for the said task or the personnel according to access rights policy.
wherein task information means the information about a specific task comprising task date, task time, task completion date, task project; task details, task completion criteria, task scope, alternative tasks and task begin criteria
access rights policy means for establishing access rights of a personnel to have read or write access to the tasks assigned by specific person (task controller) and or the tasks assigned to a specific person or group (task personnel)
said method utilizing a data processing assembly operable under the control of program means embodied on a machine-readable storage medium that provides a planning and management system for coordinating said plurality of tasks.

15. A method of a planning and managing plurality of tasks to be carried out by a plurality of personnel or group and governed by access rights policy, each of the tasks having task information including or excluding identified task date, identified task time, identified task completion date, identified task project, identified task details, identified task completion criteria, identified task scope, identified alternative tasks, identified task begin criteria relevant, said system including:
identifying task personnel or group responsible for execution of tasks;
auto allocating task controller who assigns task, and
transferring task information to and/or between task personnel and controllers such that task information relevant to a specific task are provided to and accessible by the personnel assign the task and the task personnel or group responsible for the said task or the personnel according to access rights policy or by and or by administrator.
wherein task information means the information about a specific task comprising task date, task time, task completion date, task project; task details, task completion criteria, task scope, alternative tasks and task begin criteria
access rights policy means for establishing access rights of a personnel to have read or write access to the tasks assigned by specific person (task controller) and or the tasks assigned to a specific person or group (task personnel)

16. A method as claimed in claim 15, said method including:
using the said system through computers;

17. A method of a planning and managing plurality of tasks to be carried out by a plurality of personnel or group and governed by access rights policy, each of the tasks having task information including or excluding identified task date, identified task time, identified task completion date, identified task project, identified task details, identified task completion criteria, identified task scope, identified alternative tasks, identified task begin criteria relevant, said system including:
identifying task personnel or group responsible for execution of tasks;
auto allocating task controller who assigns task, and
transferring task information to and/or between task personnel and controllers such that task information relevant to a specific task are provided to and accessible by the personnel assign the task and the task personnel or group responsible for the said task or the personnel according to access rights policy..
wherein task information means the information about a specific task comprising task date, task time, task completion date, task project; task details, task completion criteria, task scope, alternative tasks and task begin criteria
access rights policy means for establishing access rights of a personnel to have read or write access to the tasks assigned by specific person (task controller) and or the tasks assigned to a specific person or group (task personnel)
said method utilizing a data processing assembly operable under the control of program means embodied on a machine-readable storage
medium that provides a task management system for coordinating said plurality of tasks, said task management system including:
transfer means for transferring said task details to and/or between said task personnel and controllers;
wherein a task information are modified by any one or more of the following operations:
moving a single task;
moving multiple tasks;
copy a single task;
copy multiple tasks;
deleting a task;
deleting multiple tasks;
marking a task for completion;
marking multiple tasks as completed;
copying and pasting a task, and
copy and pasting multiple tasks;

18. A method as claimed in claim 17, wherein said task information including or excluding task details, task completion criteria, task scope, alternative tasks and task begin criteria when transferred are displayed to said task controller and said task personnel or to the personnel having access rights to access tasks of task controller and task personnel.

19. A method as claimed in claim 17, wherein said task information including or excluding task details, task completion criteria, task scope, alternative tasks and task begin criteria when transferred are displayed in messenger if task personnel is online.

20. A method as claimed in claim 17, wherein said task information including or excluding task details, task completion criteria, task scope, alternative tasks and task begin criteria when transferred are delivered to the task personnel through different devices such as mobile, pager, screen or any other sort of device able to display the said information.

21. A method as claimed in claim 17, wherein said task information including or excluding task details, task completion criteria, task scope, alternative tasks and task begin criteria when transferred and received feeds back the task controller about the receipt of tasks assigned to different personnel.

22. A method as claimed in claim 17, wherein personnel involved can communicate with other personnel through instant messenger operable under the said system.

23. A method as claimed in claim 17, wherein said task information including or excluding task details, task completion criteria, task scope, alternative tasks and task begin criteria when modified by task personnel or any other personnel except task controller does not commit the changes until approval of changes is made by the task controller.
